(19) United States
(12) Patent Application Publication
(10) Pub. No.: US 2022/0356720 A1
(43) Pub. Date: Nov. 10, 2022

(54) FOLDABLE STRUCTURE FOR 3D PRINTER FOR BUILDING CONSTRUCTION AND METHODS FOR OPERATING THE SAME

(71) Applicants: Hisys Co., Ltd., Gimpo (KR); Black Buffalo 3D Corporation, New York, NY (US)

(72) Inventor: GUNHO LEE, Seoul (KR)

(21) Appl. No.: 17/736,039

(22) Filed: May 3, 2022

Related U.S. Application Data
(60) Provisional application No. 63/185,279, filed on May 6, 2021.

(51) Int. Cl. E04G 21/04

(52) U.S. Cl. CPC E04G 21/0445; E04G 21/0427; B33Y 30/00

(57) ABSTRACT

A foldable structure for supporting a 3D printer for building components, the foldable structure having expanded and compact positions includes: first supports spaced apart from each other in a first direction and extending in a second direction intersecting the first direction to support the foldable structure on a ground surface; second supports disposed respectively on the first supports, and being supported in a third direction for linear movement along the first supports in the second direction in the expanded position of the foldable structure; and a third support disposed between the second supports. The second supports include: shafts; and hinges disposed between the shafts and the first supports to tilt the shafts toward the first supports to transition from the expanded position to the compact position and to raise the shafts from the first supports to transition from the compact position to the expanded position.

### CROSS-REFERENCE TO RELATED APPLICATION

This application claims priority from and the benefit of U.S. Provisional Patent Application No. 63/185,279, filed on May 6, 2021, which is hereby incorporated by reference for all purposes as if fully set forth herein.

### BACKGROUND

### Field

The invention relates generally to 3D printers used in the construction industry and, more particularly, to foldable structures for 3D printers for building construction and methods for operating the same.

### Discussion of the Background

A contour crafting method is mainly used in 3D (three dimensional) printer technologies for building construction. The contour crafting is a method in which thin construction materials such as cement are applied and stacked continuously, which has been studied for many years.

The 3D printer for building construction components is inevitably large in size. For example, the machinery of the 3D printer may have a gantry structure to build the components, and may include large frame shafts to support a nozzle assembly to build the components.

The above information disclosed in this Background section is only for understanding of the background of the inventive concepts, and, therefore, it may contain information that does not constitute prior art.

### SUMMARY

Applicant recognized that, in a case where a 3D printer for building components includes a conventional frame structure such as a gantry structure, relatively great resources such as lots of equipment, manpower, and cost are required for installation, disassembly, and transport of the 3D printer, and a long work time is required. This causes a delay in the entire work processes, and disadvantages in speed and economy of the work.

Foldable structures for 3D printers for building construction constructed according to the principles and illustrative embodiments of the invention and and methods for operating the same according to the principles and illustrative embodiments of the invention include foldable parts to move the 3D printers between an expanded position and a compact position. Accordingly, the 3D printer may be made to have a reduced and/or minimized volume using relatively less resources, and work efficiency to disassemble, transport, store, and install may be improved.

Also, the 3D printers and the methods are capable of securely and/or stably moving the 3D printers between the expanded and compact positions. For example, the 3D printer may include first supports disposed on the ground surface and second supports disposed on the first supports for linear movement along the first supports, and the second supports may be tilted toward and raised from the first supports while maintaining the second supports at ends of the first supports.

Additional features of the inventive concepts will be set forth in the description which follows, and in part will be apparent from the description, or may be learned by practice of the inventive concepts.

According to one aspect of the invention, a foldable structure for supporting a 3D printer for building components, the foldable structure having expanded and compact positions includes: first supports spaced apart from each other in a first direction and extending in a second direction intersecting the first direction to support the foldable structure on a ground surface; second supports disposed respectively on the first supports, and being supported in a third direction intersecting the first and second directions for linear movement along the first supports in the second direction in the expanded position of the foldable structure; and a third support disposed between the second supports. The second supports include: shafts; and hinges disposed between the shafts and the first supports to tilt the shafts toward the first supports to transition from the expanded position to the compact position and to raise the shafts from the first supports to transition from the compact position to the expanded position.

At least one of the following conditions may apply: i) the first supports include ground frames, ii) the second supports include vertical frames, iii) the third support includes a horizontal frame, iv) the shafts include vertical frame shafts, and v) the hinges include hinge assemblies.

The second supports may further include bias members connected to the shafts to tilt and raise the shafts about the hinges when the foldable structure is moved between the expanded and compact positions.

The first supports may maintain the second supports at ends of the first supports in the second direction when the foldable structure is moved between the expanded and compact positions.

The second supports may further include a moving mechanism disposed between the hinges and the first supports to move the second supports along the first supports. The first supports may include retention members disposed at the ends of the first supports in the second direction to hold the moving mechanism of the second supports.

The first supports may include ground frames including: ground frame shafts extending in the second direction to guide the linear movement of the second supports; and support members spaced apart from the retention members and rotatably connected to the ground frame shafts; and bias members to rotate the support members to support the tilted shafts when moving the foldable structure to the compact position.

The foldable structure may further include wheels disposed below the first supports to move the foldable structure, and wheel direction controllers to limit the rolling directions of the wheels to the first direction and a direction opposite to the first direction.

The foldable structure may further include drive motors to roll the wheels after the rolling directions are adjusted such that a distance between the first supports changes when the foldable structure moves between the expanded and compact positions, and wherein the third support includes non-foldable parts and a foldable part disposed between the non-foldable parts, the foldable parts being folded or unfolded in response to a change in the distance.

According to another aspect of the invention, a method of moving a 3D printer for building components from an expanded to a compact position, the 3D printer having first supports spaced apart from each other in a first direction and extending in a second direction intersecting the first direction, second supports disposed respectively on the first supports and being supported in a third direction intersecting the first and second directions for linear movement along the first supports in the second direction, and hinges to pivot the second supports relative the first supports, the method includes the steps of: moving the second supports to ends of the first supports in the second direction; maintaining the second supports at the ends of the first supports; and pivoting at least parts of the second supports about the hinges toward the first supports when the second supports are maintained at the ends of the first supports.

The method may further include the steps of: supporting the first supports on a ground surface using outriggers disposed below the first supports before the second supports moves to the ends of the first supports.

The step of pivoting may include tilting at least parts of the second supports about the hinges toward the first supports.

The method may further include the steps of: supporting the pivotable parts of the second supports using support members that are spaced apart from the ends of the first supports and disposed on the first supports.

The 3D printer may have wheels disposed below the first supports and a third support disposed between the second supports and having a foldable part, and the method may further include the steps of: limiting the rolling directions of the wheels to the first direction and a direction opposite to the first direction; and rolling the wheels after the rolling directions are limited such that a distance between the first supports decreases to fold the foldable part.

At least one of the following conditions may apply: i) the first supports include ground frames, ii) the second supports include vertical frames, and iii) the hinges include hinge assemblies.

According to still another aspect of the invention, a method of moving a 3D printer for building components from a compact to an expanded position, the 3D printer having first supports spaced apart from each other in a first direction and extending in a second direction intersecting the first direction, second supports disposed respectively on the first supports and being supported in a third direction intersecting the first and second directions for linear movement along the first supports in the second direction, hinges to pivot the second supports relative the first supports, a third support disposed between the second supports and having a foldable part, and wheels disposed below the first supports, the method includes the steps of: supporting the first supports on a ground surface to lift the wheels; limiting the rolling directions of the wheels to the first direction and a direction opposite to the first direction; removing the support for the first supports to lower the wheels to the ground surface; rolling the wheels after the rolling directions are limited such that a distance between the first supports increases to unfold the foldable part; and pivoting at least parts of the second supports about the hinges from the first supports when the second supports are maintained at ends of the first supports in the second direction.

The step of pivoting may include pivoting at least parts of the second supports about the hinges to be raised from the first supports.

The method may further include the steps of releasing the second supports from the ends of the first supports.

At least one of the following conditions may apply: i) the first supports include ground frames, ii) the second supports include vertical frames, iii) the third support includes a horizontal frame, iv) the hinges include hinge assemblies, and v) the wheels include caster wheels.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 is a perspective view of an embodiment of a 3D printer for building components constructed according to the principles of the invention.

FIG. 2 is a perspective view of an embodiment of a part of the 3D printer of FIG. 1 adjacent to the end part of a representative one of the first and second ground frames GF1 and GF2.

FIG. 3 is a cross-sectional view of the part of the 3D printer of FIG. 2.

FIG. 4 is a cross-sectional view of the part of the 3D printer of FIG. 2 illustrating movement of the vertical frame when moving the 3D printer between expanded and compact positions.

FIG. 5 is a cross-sectional view of the part of the 3D printer of FIG. 2 illustrating movement of the bracket when moving the 3D printer between expanded and compact positions.

FIG. 6 is a perspective view of an embodiment of a region A of the 3D printer of FIG. 1.

FIG. 7 is a cross-sectional view of the part of the 3D printer of FIG. 6 illustrating the rotating support of FIG. 6 positioned parallel to the ground frame.

FIG. 8 is a cross-sectional view of the part of the 3D printer of FIG. 6 illustrating the rotating support of FIG. 6 rotated to be positioned in the third direction.

FIG. 9 is a perspective view of an embodiment of a representative one of the wheel assemblies of FIG. 1.

FIG. 10 is a flowchart of an embodiment of a method of moving a 3D printer from an expanded position to a compact position.

FIGS. 11A, 11B, 11C, and 11D are perspective views of the 3D printer at some of stages when moving the 3D printer from the expanded position to the compact position.

FIG. 12 is a flowchart of an embodiment of the step S1050 of FIG. 10.

FIG. 13 is a flowchart of an embodiment of the step S1060 of FIG. 10.

FIG. 14 is a flowchart of an embodiment of a method of moving a 3D printer from a compact position to an expanded position.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing illustrative features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

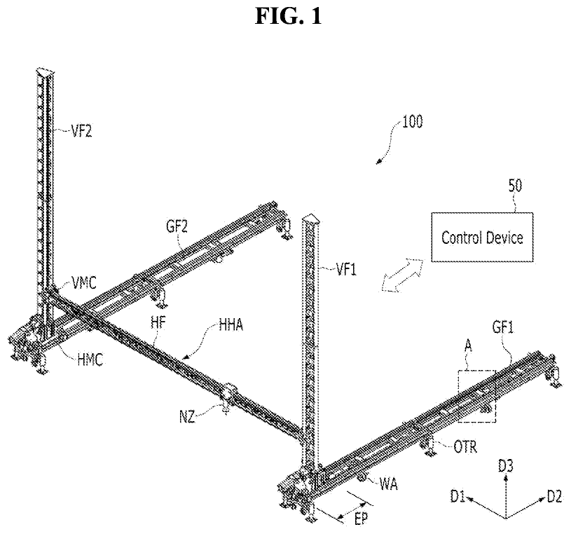

FIG. 1 is a perspective view of an embodiment of a 3D printer for building components constructed according to the principles of the invention.

Referring to FIG. 1, a 3D printer 100 includes a foldable structure to support a nozzle assembly HZ. The foldable structure may be moved between an expanded position and a compact position. The 3D printer 100 may build components when the foldable structure has the expanded position, and may have reduced and/or minimized volume when the foldable structure has the compact position. In an embodiment, the foldable structure may include outriggers OTR, wheel assemblies WA, first and second ground frames GF1 and GF2, first and second vertical frames VF1 and VF2, and a horizontal frame HF, and may be folded and unfolded to move between the expanded position and the compact position. The 3D printer 100 may further include a nozzle assembly NZ supported by the foldable structure, and a control device 50 that generates control signals to control the foldable structure and the nozzle assembly NZ.

The outriggers OTR support the first and second ground frames GF1 and GF2 on the ground surface. In an embodiment, the outriggers OTR each includes one or more hydraulic cylinders to lift and lower the first and second ground frames GF1 and GF2. For example, the outriggers OTR lower the first and second ground frames GF1 and GF2, which makes the wheel assemblies WA contact the ground surface to support the first and second ground frames GF1 and GF2 on the ground surface. The outriggers OTR may operate in response to control signals from the control device 50.

The wheel assemblies WA are disposed below the first and second ground frames GF1 and GF2. In an embodiment, the wheel assemblies WA may include caster wheels to adjust their rolling directions. The wheel assemblies WA may roll the caster wheels to move the 3D printer 100 and/or the first and second ground frames GF1 and GF2. The wheel assemblies WA may operate in response to control signals from the control device 50.

First supports of the foldable structure, which may be in the form of the first and second ground frames GF1 and GF2, are spaced apart from each other in a first direction D1 and parallel with each other. Each of the first and second ground frames GF1 and GF2 generally extends in a second direction D2 intersecting the first direction D1. The first and second ground frames GF1 and GF2 may be disposed on the outriggers OTR and/or wheel assemblies WA, and may support the first and second vertical frames VF1 and VF2 to be linearly movable in the second direction D2. In an embodiment, the first and second ground frames GF1 and GF2 each includes a ground frame shaft extending in the second direction D2 to guide the linear movement of a corresponding one of the first and second vertical frames VF1 and VF2 in the second direction D2. For example, the ground frame shaft includes one or more guide rails protruding from its body and extending in the second direction D2.

Second supports of the foldable structure, which may be in the form of the first and second vertical frames VF1 and VF2, are disposed on the first and second ground frames GF1 and GF2. The first and second vertical frames VF1 and VF2 are supported in a third direction D3 intersecting the first and second directions D1 and D2. The first and second vertical frames VF1 and VF2 are linearly movable along the first and second ground frames GF1 and GF2. In an embodiment, the first and second vertical frames VF1 and VF2 may include horizontal movement carriages HMC to move the first and second vertical frames VF1 and VF2 along the first and second ground frames GF1 and GF2. Also, the first and second vertical frames VF1 and VF2 may guide the linear movement of the horizontal frame HF in the third direction D3.

A third support of the foldable structure, which may be in the form of the horizontal frame HF, is disposed between the first and second vertical frames VF1 and VF2 and extends in the first direction D1. The horizontal frame HF is connected to the first and second vertical frames VF1 and VF2 to be linearly moveable in the third direction D3. In an embodiment, the horizontal frame HF may include vertical movement carriages VMC moveably engaged with the first and second vertical frames VF1 and VF2 to move the horizontal frame HF along the first and second vertical frames VF1 and VF2 in the third direction D3. The horizontal frame HF supports the nozzle assembly NZ.

The nozzle assembly NZ is disposed on the horizontal frame HF to be linearly moveable in the first direction D1. In an embodiment, the nozzle assembly NZ may include a movement carriage engaged with the horizontal frame HF to move along the horizontal frame HF. The nozzle assembly NZ may be connected to a material storage tank that stores materials corresponding to building components, and may discharge the materials of the material storage tank in response to control signals from the control device 50.

The control device 50 controls the overall operations of the 3D printer 100. The control device 50 may change the position of the nozzle assembly NZ by moving the first and second vertical frames VF1 and VF2 in the second direction D2, moving the horizontal frame HF in the third direction D3, and moving the nozzle assembly NZ in the first direction D1. In other words, the control device 50 may control the horizontal movement carriages HMC to move along the first and second ground frames BF1 and BF2, and control the vertical movement carriages VMC to move along the first and second vertical frames VF1 and VF2, and control the nozzle assembly NZ to move along the horizontal frame HF. As such, the control device 50 may move the first and second vertical frames VF1 and VF2, the horizontal frame HF, and the nozzle assembly NZ to change the position of the nozzle assembly NZ in the first to third directions D1 to D3, and may control the nozzle assembly NZ to discharge the materials to build the components.

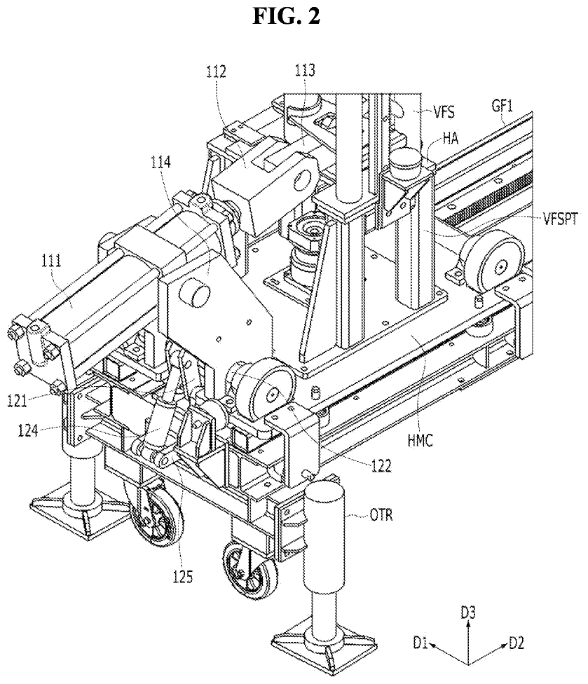

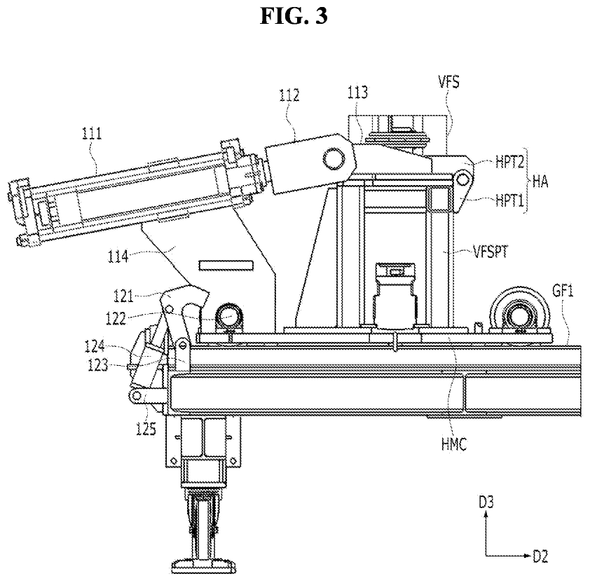

Also, the control device 50 may control movement of the 3D printer 100 between the expanded and compact positions. The control device 50 may fold and unfold the first and second vertical frames VF1 and VF2 and the horizontal frame HF by controlling elements of the 3D printer 100 such as bias members discussed herein and the wheel assemblies WA. The control device 50 may control the first and second ground frames GF1 and GF2 to maintain the first and second vertical frames VF1 and VF2 at end parts EP of the first and second ground frames GF1 and GF2 in the second direction D2 when moving the 3D printer 100 between the expanded and compact positions. In an embodiment, the first and second vertical frames VF1 and VF2 may include hinge assemblies to fold them as discussed later with reference to FIGS. 2 and 3, and the horizontal frame HF may include a horizontal hinge assembly HHA to fold the horizontal frame HF.

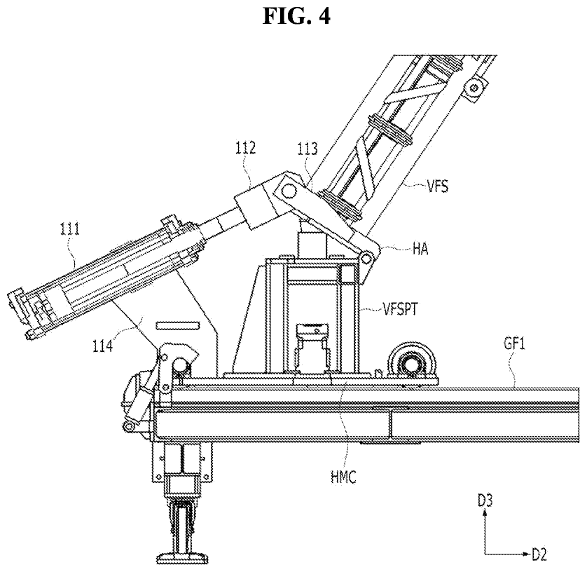

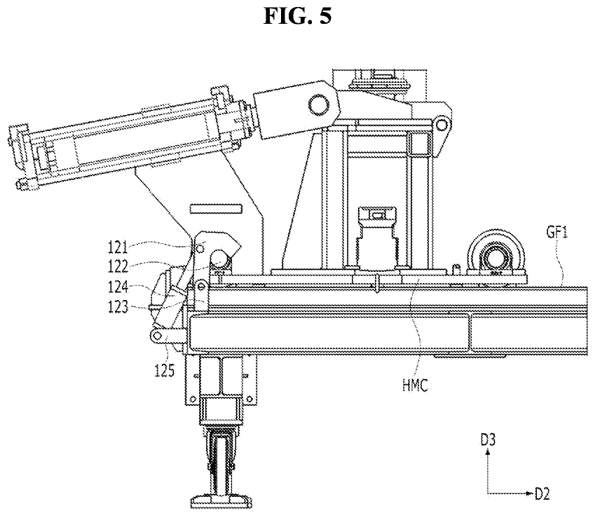

FIG. 2 is a perspective view of an embodiment of a part of the 3D printer of FIG. 1 adjacent to the end part of a representative one of the first and second ground frames GF1 and GF2. FIG. 3 is a cross-sectional view of the part of the 3D printer of FIG. 2. FIG. 4 is a cross-sectional view of the part of the 3D printer of FIG. 2 illustrating movement of the vertical frame when moving the 3D printer between expanded and compact positions. FIG. 5 is a cross-sectional view of the part of the 3D printer of FIG. 2 illustrating movement of the bracket when moving the 3D printer between expanded and compact positions.

FIG. 2 shows the part of the 3D printer 100 adjacent to the end part EP of the first ground frame GF1 for descriptive convenience, but it is understood that the part of the 3D printer 100 adjacent to the end part of the second ground frame GF2 may be configured the same as in FIG. 2. Repetitive descriptions will be omitted to avoid redundancy.

Referring to FIGS. 2 and 3, the first vertical frame VF1 of FIG. 1 may include a horizontal movement carriage HMC, a vertical frame support VFSPT, and a vertical frame shaft VFS. The vertical frame shaft VFS is supported in the third direction in the expanded position. The vertical frame support VFSPT is disposed on the horizontal movement carriage HMC to support the vertical frame shaft VFS. The horizontal movement carriage HMC may include wheels to move along the first ground frame GF1.

The first vertical frame VF1 may further include a hinge, which may be in the form of a hinge assembly HA, to guide rotation of the vertical frame shaft VFS relative to the vertical frame support VFSPT. In an embodiment, the hinge assembly HA may include a first plate HPT1 connected to the vertical frame support VFSPT and a second plate HPT2 connected to the vertical frame shaft VFS where the first and second plates HPT1 and HPT2 are rotatably engaged with each other.

The first vertical frame VF1 may further include a first bias member, which may be in the form of a first hydraulic cylinder 111, to tilt and raise the vertical frame shaft VFS about the hinge assembly HA when the 3D printer 100 is moved between the expanded and compact positions. In an embodiment, the first hydraulic cylinder 111 is connected to a cylinder connector 112, and the cylinder connector 112 is rotatably connected to a protrusion 113 of the vertical frame shaft VFS. Here, the first hydraulic cylinder 111 is rotatably engaged with one or more cylinder support plates 114 of the horizontal movement carriage HMC. In this case, as shown in FIG. 4, the vertical frame shaft VFS may be tilted about the hinge assembly HA toward the first ground frame GF1 when the piston rod of the first hydraulic cylinder 111 moves out to push the protrusion 113 of the vertical frame shaft VFS through the cylinder connector 112. Also, the vertical frame shaft VFS may be raised about the hinge assembly HA from the first ground frame GF1 when the piston rod of the first hydraulic cylinder 111 moves in to pull the protrusion 113 of the vertical frame shaft VFS through the cylinder connector 112.

As described with reference to FIG. 1, the first ground frame GF1 maintains the first vertical frames VF1 at the end part EP of the first ground frame GF1 when the 3D printer 100 is moved between the expanded and compact positions. For this, the first ground frame GF1 may include a retention member, which may be in the form of a bracket 121 to hold (or hook) the horizontal movement carriage HMC, such as a wheel axle 122 of the horizontal movement carriage HMC. For example, the bracket 121 may be rotatably connected to a first protrusion 123 of the first ground frame GF1 to hold or release the wheel axle 122 of the horizontal movement carriage HMC.

The first ground frame GF1 may further include a second bias member, which may be in the form of a second hydraulic cylinder 124, to rotate the bracket 121 relative to the first protrusion 123 of the first ground frame GF1. In an embodiment, the second hydraulic cylinder 124 is rotatably connected to both the bracket 121 and a second protrusion 125 of the first ground frame GF1. In this case, as shown in FIG. 5, the bracket 121 may rotate clockwise to hold the wheel axle 122 when the piston rod of the second hydraulic cylinder 124 moves out. The bracket 121 may rotate counterclockwise to release the wheel axle 122 when the piston rod of the second hydraulic cylinder 124 moves in.

Referring back to FIG. 1 together with FIGS. 2 and 3, for the movement of 3D printer 100 between the expanded and compact positions, the horizontal movement carriages HMC of the first and second vertical frames VF1 and VF2 are maintained at the end parts EP of the first and second ground frames GF1 and GF2, and then the vertical frame shafts VFS of the first and second vertical frames VF1 and VF2 are tilted toward or raised from the first and second ground frames GF1 and GF2. Accordingly, the vertical frame shafts VFS may be tilted and raised securely and/or stably while the vertical frame shafts VFS are relatively heavy. Therefore, the 3D printer 100 may securely and/or stably be moved between the expanded and compact positions.

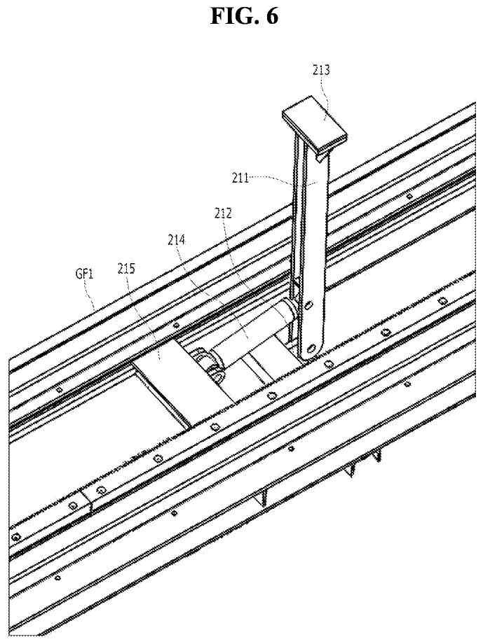

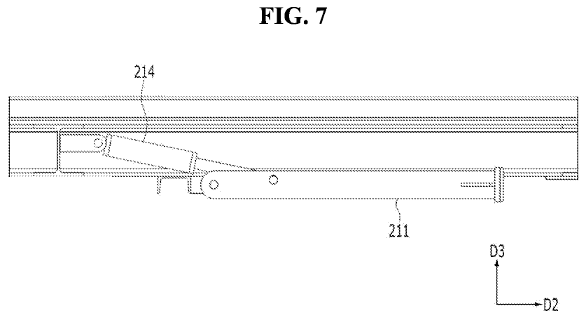

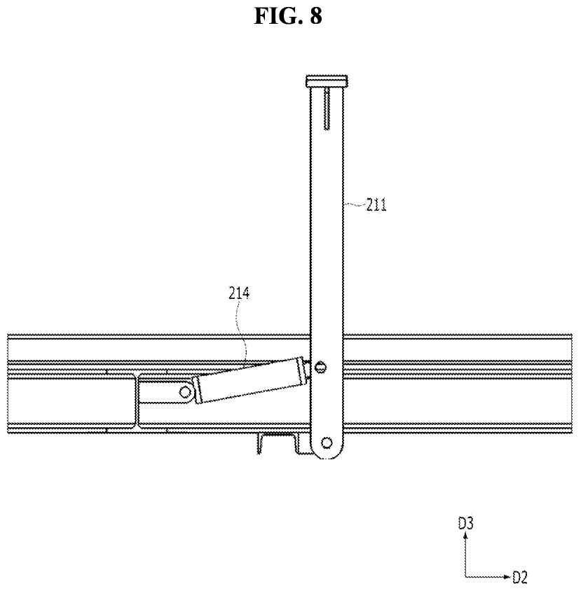

FIG. 6 is a perspective view of an embodiment of a region A of the 3D printer of FIG. 1. FIG. 7 is a cross-sectional view of the part of the 3D printer of FIG. 6 illustrating the rotating support of FIG. 6 positioned parallel to the ground frame. FIG. 8 is a cross-sectional view of the part of the 3D printer of FIG. 6 illustrating the rotating support of FIG. 6 rotated to be positioned in the third direction.

Referring to FIG. 6, the first ground frame GF1 may include a support member, which may be in the form of a rotating support 211. The rotating support 211 is spaced apart from the bracket 121 of FIGS. 2 and 3 and rotatably connected to a first fixing member 212 of the first ground frame GF1. The rotating support 211 may include a support surface 213 to support the tilted part of the first vertical frame VF1, such as the vertical frame shaft VFS of FIGS. 2 and 3.

The first ground frame GF1 may further include a bias member, which may be in the form of a hydraulic cylinder 214, to rotate the rotating support 211. In an embodiment, the hydraulic cylinder 214 may be rotatably connected to both a second fixing member 215 of the first ground frame GF1 and a body of the rotating support 211, and may be driven based on control signals from the control device 50 of FIG. 1. The rotating support 211 is positioned parallel to the ground frame GF1 when the piston rod of the hydraulic cylinder 214 moves out as shown in FIG. 7, and the rotating support 211 is rotated to be disposed in the third direction D3 when the piston rod of the hydraulic cylinder 214 moves in as shown in FIG. 8.

The second ground frame GF2 may include another pair of a rotating support and a hydraulic cylinder configured the same as the rotating support 211 and the hydraulic cylinder 214 shown in FIG. 6.

The rotating supports 211 of the first and second ground frames GF1 and GF2 may be rotated to be positioned in the third direction D3 when the 3D printer 100 is moved from the expanded position to the compact position. For example, the rotating supports 211 of the first and second ground frames GF1 and GF2 may be positioned in the third direction D3 before the vertical frame shafts VFS of the first and second vertical frames VF1 and VF2 are tilted. Accordingly, the vertical frame shafts VFS may securely and/or stably be supported on the first and second ground frames GF1 and GF2 while the vertical frame shafts VFS are relatively heavy.

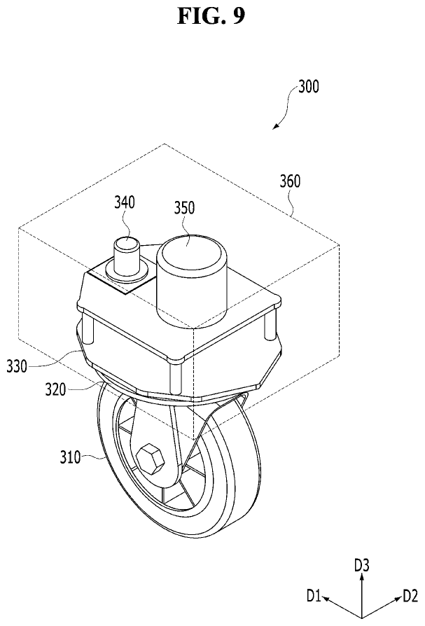

FIG. 9 is a perspective view of an embodiment of a representative one of the wheel assemblies of FIG. 1.

Referring to FIG. 9, a wheel assembly 300 may be disposed below one of the first and second ground frames GF1 and GF2, and may include a wheel, which may be in the form of a caster wheel 310. The caster wheel 310 may have a variable rolling direction.

In association with the caster wheel 310, the wheel assembly 300 may include a wheel support plate 320, a motor mount 330, a wheel direction controller 340, a drive motor 350, and a motor housing 360. The wheel support plate 320 may support the caster wheel 310, and may rotatably be connected to the motor mount 330. The motor mount 330 may be disposed on the wheel support plate 320, and may mount the wheel direction controller 340 and the drive motor 350. The motor housing 360 covers the wheel direction controller 340 and the drive motor 350 to protect them.

The wheel direction controller 340 may adjust and limit the rolling direction of the caster wheel 310 in response to control signals from the control device 50. The wheel direction controller 340 may rotate the wheel support plate 320 relative to the motor mount 330 to adjust and limit the rolling direction of the caster wheel 310 to a desired direction such as the first direction D1, the direction opposite to the first direction D1, the second direction D2, or the direction opposite to the second direction D2.

The drive motor 350 may roll the caster wheel 310 in response to control signals from the control device 50.

Referring back to FIG. 1 together with FIG. 9, the wheel assemblies 300 of the 3D printer 100 may move the first and second ground frames GF1 and GF2 to fold and unfold the horizontal frame HF. The horizontal frame HF includes non-foldable parts such as frame shafts, and a foldable part which may be in the form of the horizontal hinge assembly HHA disposed between the frame shafts. The wheel direction controller 340 of each of the wheel assemblies 300 may limit the rolling direction to the first direction D1 or the direction opposite to the first direction D1, and the drive motor 350 of each of the wheel assemblies 300 may roll the caster wheel 310 to change a distance between the first and second ground frames GF1 and GF2. The distance between the first and second ground frames GF1 and GF2 may decrease to fold the horizontal frame HF about the horizontal hinge assembly HHA when the 3D printer 100 is moved from the expanded position to the compact position. The distance between the first and second ground frames GF1 and GF2 may increase to unfold the horizontal frame HG about the horizontal hinge assembly HHA when the 3D printer 100 is moved from the compact position to the expanded position.

As such, the first and second vertical frames VF1 and VF2 and the horizontal frame HF may be folded and unfolded when moving the 3D printer 100 between the expanded and compact positions, and accordingly the 3D printer 100 may be made to have a reduced and/or minimized volume using relatively less resources. The 3D printer 100 in the compact position may have a relative less volume to be loaded in a vehicle. Therefore, equipment such as a crane and manpower required for disassembling, transporting, storing, and installing the 3D printer 100 may be reduced and work efficiency may be improved. Such a 3D printer 100 may have benefits including being economical and easy to disassemble, transport, store, transport, and install.

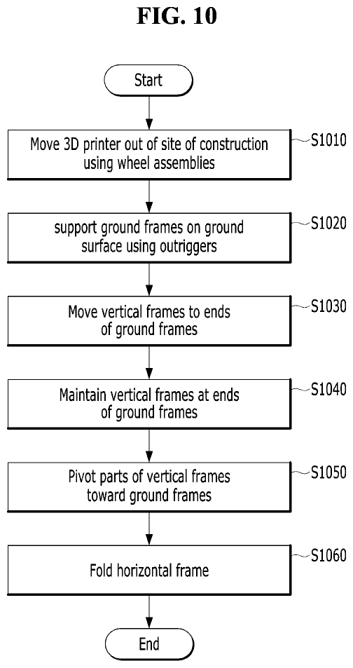

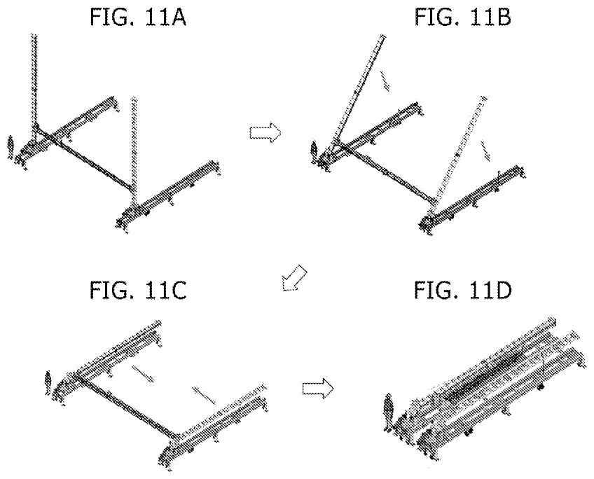

FIG. 10 is a flowchart of an embodiment of a method of moving a 3D printer from an expanded position to a compact position. FIGS. 11A, 11B, 11C, and 11D are perspective views of the 3D printer at some of stages when moving the 3D printer from the expanded position to the compact position.

Referring to FIGS. 1 and 10, at step S1010, the 3D printer 100 is moved out of the site of construction using the wheel assemblies WA. For example, the rolling direction of the wheel assemblies WA may be adjusted and limited in the second direction, and then the wheels may be rolled to move the 3D printer 100 out of the site of construction.

At step S1020, the first and second ground frames GF1 and GF2 are supported on the ground surface using outriggers OTR to fix them on the ground surface to securely and/or stably move the 3D printer 100 to the compact position. The wheel assemblies WA may be lifted from the ground surface.

At step S1030, after the first and second ground frames GF1 and GF2 are supported on the ground surface, the first and second vertical frames VF1 and VF2 are moved to the end parts EP of the first and second ground frames GF1 and GF2 as shown in FIG. 11A.

At step S1040, the first and second ground frames GF1 and GF2 maintain the first and second vertical frames VF1 and VF2 at the end parts EP. In an embodiment, the first and second ground frames GF1 and GF2 each may include the bracket 121 as shown in FIGS. 2 and 3, and the brackets 121 of the first and second ground frames GF1 and GF2 may hold the horizontal movement carriages HMC of the first and second vertical frames VF1 and VF2.

At step S1050, parts of the first and second vertical frames VF1 and VF2 are pivoted toward the first and second ground frames GF1 and GF2 as shown in FIG. 11B. The parts of the first and second vertical frames VF1 and VF2 may be tilted securely and/or stably since the first and second vertical frames VF1 and VF2 are maintained at the end parts EP.

At step S1060, the horizontal frame HF is folded about the horizontal hinge assembly HHA by reducing the distance between the first and second ground frames GF1 and GF2 as shown in FIG. 11C. Accordingly, the 3D printer 100 may have the compact position as shown in FIG. 11D.

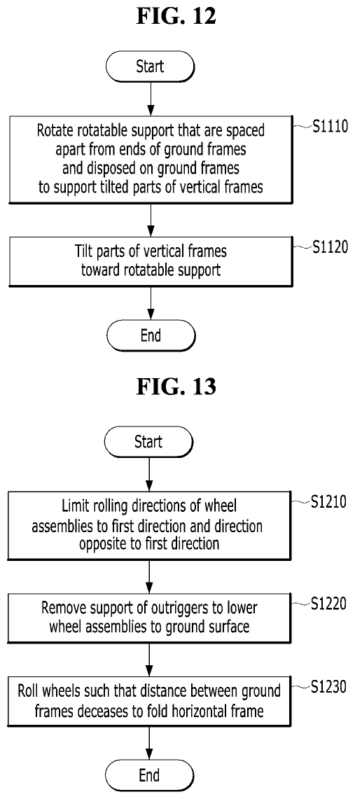

FIG. 12 is a flowchart of an embodiment of the step S1050 of FIG. 10.

Referring to FIGS. 1 and 12, at step S1110, rotatable supports of the first and second ground frames GF1 and GF2 are driven to rotate to support tilted parts of the first and second vertical frames VF1 and VF2. The rotatable supports are spaced apart from the end parts EP and disposed on the first and second ground frames GF1 and GF2 as described with reference to FIGS. 6 to 8.

At step S1120, the parts of the first and second vertical frames VF1 and VF2 are tilted toward the first and second ground frames GF1 and GF2 to be supported by the rotatable supports. Accordingly, the tilted parts of the first and second vertical frames VF1 and VF2 may securely and/or stably be supported on the first and second ground frames GF1 and GF2.

FIG. 13 is a flowchart of an embodiment of the step S1060 of FIG. 10.

Referring to FIGS. 1 and 13, at step S1210, rolling directions of the wheels of the wheel assemblies WA are adjusted and limited to the first direction D1 and the direction opposite to the first direction D1.

At step S1220, the support of the outriggers OTR is removed to lower the wheel assemblies WA to the ground surface.

At step S1230, the wheel assemblies WA roll the wheels such that the distance between the first and second ground frames GF1 and GF2 decreases. The horizontal frame HF has the horizontal hinge assembly HHA, and accordingly the horizontal frame HF is folded about the horizontal hinge assembly HHA in response to the decrease of the distance between the first and second ground frames GF1 and GF2.

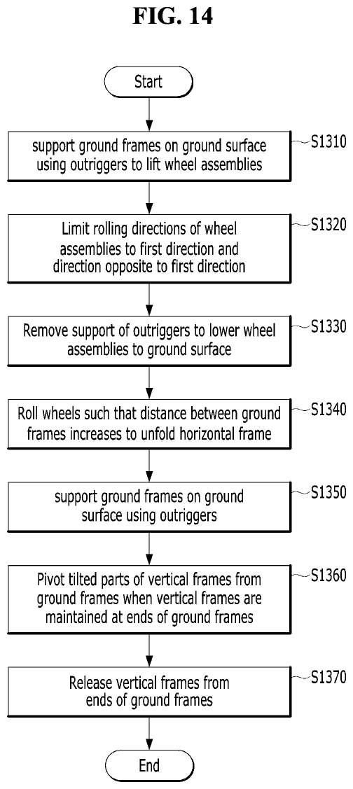

FIG. 14 is a flowchart of an embodiment of a method of moving a 3D printer from the compact position to the expanded position.

Referring to FIGS. 1 and 14, a flow of processes of moving the 3D printer 100 from the compact position to the expanded position may generally be performed in the reverse order of the processes of moving the 3D printer 100 from the expanded position to the compact position.

At step S1310, the first and second ground frames GF1 and GF2 are supported on the ground surface using the outriggers OTR to lift the wheel assemblies WA. At step S1320, the rolling directions of the wheels of the wheel assemblies WA are adjusted and limited to the first direction D1 and the direction opposite to the first direction D1 while lifting the wheel assemblies WA. Then, at step S1330, the support of the outriggers OTR is removed to lower the wheel assemblies WA to the ground surface.

At step S1340, the wheel assemblies WA roll the wheels such that the distance between the first and second ground frames GF1 and GF2 increases to unfold the horizontal frame HF about the horizontal hinge assembly HHA.

At step S1350, the first and second ground frames GF1 and GF2 are supported on the ground surface again using the outriggers OTR to ensure security and/or stability when disposing the first and second vertical frames VF1 and VF2 in the third direction in the subsequent steps.

At step S1360, the tilted parts of the first and second vertical frames VF1 and VF2 are pivoted to be raised from the first and second ground frames GF1 and GF2. At this time, the first and second vertical frames VF1 and VF2 are maintained at the end parts EP of the first and second ground frames GF1 and GF2 by using, for example, the bracket 121 shown in FIGS. 2 and 3. Accordingly, the tilted parts of the first and second vertical frames VF1 and VF2 may be raised securely and/or stably.

At step S1370, the first and second vertical frames VF1 and VF2 are released from the end parts EP to allow the first and second vertical frames VF1 and VF2 to move along the first and second ground frames GF1 and GF2 for building construction. The bracket 121 of each of the first and second ground frames GF1 and GF2 may rotate counterclockwise to release the horizontal movement carriages HMC of the first and second vertical frames VF1 and VF2.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A foldable structure for supporting a 3D printer for building components, the foldable structure having expanded and compact positions and comprising:
first supports spaced apart from each other in a first direction and extending in a second direction intersecting the first direction to support the foldable structure on a ground surface;
second supports disposed respectively on the first supports, and being supported in a third direction intersecting the first and second directions for linear movement along the first supports in the second direction in the expanded position of the foldable structure; and
a third support disposed between the second supports,
wherein the second supports comprise:
shafts; and
hinges disposed between the shafts and the first supports to tilt the shafts toward the first supports to transition from the expanded position to the compact position and to raise the shafts from the first supports to transition from the compact position to the expanded position.

2. The foldable structure of claim 1, wherein at least one of the following conditions applies: i) the first supports comprise ground frames, ii) the second supports comprise vertical frames, iii) the third support comprises a horizontal frame, iv) the shafts comprise vertical frame shafts, and v) the hinges comprise hinge assemblies.

3. The foldable structure of claim 1, wherein the second supports further comprise bias members connected to the shafts to tilt and raise the shafts about the hinges when the foldable structure is moved between the expanded and compact positions.

4. The foldable structure of claim 1, wherein the first supports maintain the second supports at ends of the first supports in the second direction when the foldable structure is moved between the expanded and compact positions.

5. The foldable structure of claim 1, wherein:
the second supports further comprises a moving mechanism disposed between the hinges and the first supports to move the second supports along the first supports; and
the first supports comprise retention members disposed at the ends of the first supports in the second direction to hold the moving mechanism of the second supports.

6. The foldable structure of claim 5, wherein the first supports comprise ground frames including:
ground frame shafts extending in the second direction to guide the linear movement of the second supports; and
support members spaced apart from the retention members and rotatably connected to the ground frame shafts; and
bias members to rotate the support members to support the tilted shafts when moving the foldable structure to the compact position.

7. The foldable structure of claim 1, further comprising wheels disposed below the first supports to move the foldable structure, and wheel direction controllers to limit the rolling directions of the wheels to the first direction and a direction opposite to the first direction.

8. The foldable structure of claim 7, further comprising drive motors to roll the wheels after the rolling directions are adjusted such that a distance between the first supports changes when the foldable structure moves between the expanded and compact positions,
wherein the third support comprises non-foldable parts and a foldable part disposed between the non-foldable parts, the foldable parts being folded or unfolded in response to a change in the distance.

9. A method of moving a 3D printer for building components from an expanded to a compact position, the 3D printer having first supports spaced apart from each other in a first direction and extending in a second direction intersecting the first direction, second supports disposed respectively on the first supports and being supported in a third direction intersecting the first and second directions for linear movement along the first supports in the second direction, and hinges to pivot the second supports relative the first supports,
the method comprising the steps of:
moving the second supports to ends of the first supports in the second direction;
maintaining the second supports at the ends of the first supports; and
pivoting at least parts of the second supports about the hinges toward the first supports when the second supports are maintained at the ends of the first supports.

10. The method of claim 9, further comprising the steps of:
supporting the first supports on a ground surface using outriggers disposed below the first supports before the second supports moves to the ends of the first supports.

11. The method of claim 9, wherein the step of pivoting comprises tilting at least parts of the second supports about the hinges toward the first supports.

12. The method of claim 9, further comprising the steps of:
supporting the pivotable parts of the second supports using support members that are spaced apart from the ends of the first supports and disposed on the first supports.

13. The method of claim 9, wherein the 3D printer has wheels disposed below the first supports and a third support disposed between the second supports and having a foldable part, and the method further comprises the steps of:
limiting the rolling directions of the wheels to the first direction and a direction opposite to the first direction; and
rolling the wheels after the rolling directions are limited such that a distance between the first supports decreases to fold the foldable part.

14. The method of claim 9, wherein at least one of the following conditions applies: i) the first supports comprise ground frames, ii) the second supports comprise vertical frames, and iii) the hinges comprise hinge assemblies.

15. A method of moving a 3D printer for building components from a compact to an expanded position, the 3D printer having first supports spaced apart from each other in a first direction and extending in a second direction intersecting the first direction, second supports disposed respectively on the first supports and being supported in a third direction intersecting the first and second directions for linear movement along the first supports in the second direction, hinges to pivot the second supports relative the first supports, a third support disposed between the second supports and having a foldable part, and wheels disposed below the first supports,
the method comprising the steps of:
supporting the first supports on a ground surface to lift the wheels;
limiting the rolling directions of the wheels to the first direction and a direction opposite to the first direction;
removing the support for the first supports to lower the wheels to the ground surface;
rolling the wheels after the rolling directions are limited such that a distance between the first supports increases to unfold the foldable part; and
pivoting at least parts of the second supports about the hinges from the first supports when the second supports are maintained at ends of the first supports in the second direction.

16. The method of claim 15, wherein the step of pivoting comprises pivoting at least parts of the second supports about the hinges to be raised from the first supports.

17. The method of claim 15, further comprising the steps of releasing the second supports from the ends of the first supports.

18. The method of claim 15, wherein at least one of the following conditions applies: i) the first supports comprise ground frames, ii) the second supports comprise vertical frames, iii) the third support comprises a horizontal frame, iv) the hinges comprise hinge assemblies, and v) the wheels comprise caster wheels.
